(19) United States
(12) Patent Application Publication
(10) Pub. No.: US 2012/0299981 A1
(43) Pub. Date: Nov. 29, 2012

(54) PLASMA DISPLAY DEVICE AND METHOD FOR DRIVING A PLASMA DISPLAY PANEL

(76) Inventors: Takahiko Origuchi, Osaka (JP); Hiroko Yamamoto, Osaka (JP); Minoru Takeda, Osaka (JP)

(21) Appl. No.: 13/576,133

(22) PCT Filed: Feb. 3, 2011
(86) PCT No.: PCT/JP2011/000606

§ 371 Date: Jul. 30, 2012

(30) Foreign Application Priority Data
Feb. 5, 2010 (JP) 2010-023889

(51) Int. Cl. G09G 5/10; G09G 3/28

(52) U.S. Cl. 345/690; 345/60

(57) ABSTRACT

The present invention allows a plasma display panel to have gradation levels being sufficient in number and to have stable address discharge. In the plasma display apparatus having a panel and a driver circuit, the driver circuit drives the panel on the subfield structure that satisfies the following. One field has a first subfield group and a second subfield group temporally successive to the first subfield group. Each of the subfield groups is formed of a plurality of temporally successive subfields. The luminance weight increases in the order of occurrence of the subfields within each subfield group. The first subfield of the second subfield group has a luminance weight smaller than that of the last subfield of the first subfield group. When a gradation having a level greater than a gradation threshold is displayed, the first subfield of the second subfield group has no light emission.

### TECHNICAL FIELD

The present invention relates to a plasma display apparatus using an AC surface discharge plasma display panel and also relates to a driving method of a plasma display panel.

### BACKGROUND ART

An AC surface discharge panel, i.e. a typical plasma display panel (hereinafter, simply referred to as “panel”), has a plurality of discharge cells between a front substrate and a rear substrate oppositely disposed to each other. On a glass substrate of the front substrate, a plurality of display electrode pairs, each including a scan electrode and a sustain electrode, is arranged in parallel with each other. A dielectric layer and a protective layer are formed over the display electrode pairs.

On a glass substrate of the rear substrate, a plurality of data electrodes is arranged in parallel with each other, and over which, a dielectric layer is formed so as to cover them. On the dielectric layer, a plurality of barrier ribs is formed so as to be parallel with the data electrodes. A phosphor layer is formed on the surface of the dielectric layer and on the side surface of the barrier ribs.

The front substrate and the rear substrate are oppositely located in a manner that the display electrode pairs are positioned orthogonal to the data electrodes, and then the two substrates are sealed with each other via discharge space therebetween. The discharge space is filled with, for example, a discharge gas containing xenon at a partial pressure of 5%. Discharge cells are formed at intersections of the display electrode pairs and the data electrodes. In the panel with the structure above, ultraviolet rays are generated by gas discharge in each discharge cell. The ultraviolet rays excite phosphors of the red (R) color, green (G) color, and blue (B) color so that light is emitted for the display of a color image.

A typically used driving method for the panel is a subfield method. In the subfield method, gradations are displayed by dividing one field into a plurality of subfields and causing light emission or no light emission in each discharge cell in each subfield. Each of the subfields has an initializing period, an address period, and a sustain period.

In the initializing period, a voltage with an initializing waveform is applied to each scan electrode to generate an initializing discharge in each discharge cell. The initializing discharge forms wall charge necessary for the subsequent address operation, and generates priming particles (i.e., excited particles for generating a discharge) for providing an address discharge with stability.

In the address period, scan pulses are sequentially applied to the scan electrodes, at the same time, address pulses are selectively applied to the data electrodes according to an image signal to be displayed. The application of voltage generates an address discharge between a scan electrode and a data electrode at a discharge cell to have light emission, and forms wall charge in the discharge cell (hereinafter, the address operation is also referred collectively as “addressing”).

In the sustain period, sustain pulses in number predetermined for each subfield are applied alternately to the scan electrodes and the sustain electrodes of the display electrode pairs. The application of the pulses generates a sustain discharge in the discharge cells having undergone the address discharge and causes the phosphor layers to emit light in the discharge cells, by which each discharge cell emits light at a luminance corresponding to a luminance weight determined for each subfield. (Hereinafter, light emission of a discharge cell caused by a sustain discharge may be represented by “light-on” and no light emission of a discharge cell may be represented by “light-off”). Thus, each discharge cell of the panel emits light at a luminance corresponding to the gradation values of image signals, displaying an image in the image display area of the panel.

To drive the panel, the plasma display apparatus has a scan electrode driver circuit, a sustain electrode driver circuit, and a data electrode driver circuit. Each of the driver circuit applies a driving voltage waveform to each electrode to display an image on the panel.

As an attempt of the subfield method, a driving method having an improvement in contrast ratio has been disclosed. In the method, an initializing discharge is generated by a voltage waveform with a moderate change, and further, an initializing discharge is generated selectively in the discharge cells having undergone a sustain discharge. As a result, the light emission unrelated to gradation display is minimized, which contributes to enhanced contrast ratio.

Specifically, out of a plurality of subfields, one subfield has an all-cell initializing operation in the initializing period, and other subfields have a selective initializing operation in each initializing period. In the all-cell initializing operation, an initializing discharge is generated in all the discharge cells. In the selective initializing operation, an initializing discharge is generated only in the discharge cells having undergone a sustain discharge in the sustain period of the immediately preceding subfield. As a result, the light emission unrelated to gradation display is limited to the light emission caused by the discharge in the all-cell initializing operation, by which an image with enhanced contrast is obtained (for example, see patent literature 1).

Recently, with the trend moving toward increasingly greater size and definition of the panel, the size of a discharge cell is becoming microscopic. Accordingly, it is further difficult to control wall charge formed in such a microscopic discharge cell. In a plasma display apparatus having a high-definition panel, the structural difficulty can invite operating malfunction. For example, no address discharge occurs in the discharge cell having undergone an address operation for generating an address discharge (i.e., addressing failure). If the addressing failure occurs, the panel cannot display image properly, resulting in degraded image display quality.

### CITATION LIST

### Patent Literature

PTL1

Japanese Patent Unexamined Publication No. 2000-242224

### SUMMARY OF THE INVENTION

The plasma display apparatus of the present invention includes the following elements:
a panel having a plurality of discharge cells arranged therein, each of the discharge cells having a data electrode and a display electrode pair which is formed of a scan electrode and a sustain electrode; and
a driver circuit for driving the panel.

The driver circuit forms one field of a plurality of subfields, each of the subfields have an address period where address pulses are applied to the discharge cells to be lit and a sustain period where sustain pulses corresponding in number to luminance weight are applied to the display electrode pairs. The driver circuit has a first subfield group and a second subfield group temporally successive to the first subfield group in the one field. The driver circuit forms each of the first subfield group and the second subfield group of a plurality of temporally successive subfields. At the same time, the driver circuit determines the luminance weight to each subfield so as to satisfy the following:
the luminance weight increases in the order of occurrence of the subfields; and
the first subfield of the second subfield group has a luminance weight smaller than that of the last subfield of the first subfield group.

Further, when a gradation having a level greater than a gradation threshold is to be displayed on the panel, the driver circuit determines that the first subfield of the second group has no light emission.

The structure above allows a panel, even it is a high-definition large-sized panel, to have gradation level being sufficient in number and to have stable address discharge.

The present invention provides a method for driving a panel, the panel having a plurality of discharge cells arranged therein, each of the discharge cells having a data electrode and a display electrode pair which is formed of a scan electrode and a sustain electrode. In the method, one field is formed of a plurality of subfields, each of the subfields have an address period where address pulses are applied to the discharge cells to be lit and a sustain period where sustain pulses corresponding in number to luminance weight are applied to the display electrode pairs. One field has a first subfield group and a second subfield group temporally successive to the first subfield group. The luminance weight to each subfield is determined so as to satisfy the following:
the luminance weight increases in the order of occurrence of the subfields; and
the first subfield of the second subfield group has a luminance weight smaller than that of the last subfield of the first subfield group.

Further, when a gradation having a level greater than a gradation threshold is to be displayed on the panel, the first subfield of the second group has no light emission.

The method above allows a panel, even it is a high-definition large-sized panel, to have decrease in power consumption and to have stable address discharge in the subfield immediately after a subfield with no generation of sustain pulses.

### BRIEF DESCRIPTION OF THE DRAWINGS

FIG. 1 is an exploded perspective view showing a structure of a panel for use in a plasma display apparatus in accordance with an exemplary embodiment of the present invention.

FIG. 2 is an electrode array diagram of the panel for use in the plasma display apparatus in accordance with the exemplary embodiment.

FIG. 3 is a circuit block diagram of the plasma display apparatus in accordance with the exemplary embodiment.

FIG. 4 is a chart of driving voltage waveforms applied to respective electrodes of the panel used for the plasma display apparatus in accordance with the exemplary embodiment.

FIG. 5 schematically shows driving voltage waveforms applied in one field to respective electrodes of the panel used for the plasma display apparatus in accordance with the exemplary embodiment.

FIG. 6 is a graph showing the relation between amplitude of a scan pulse and a length of standby time Ts for generating a stable address discharge in the panel used for the plasma display apparatus in accordance with the exemplary embodiment.

FIG. 7A illustrates standby time Ts in accordance with the exemplary embodiment.

FIG. 7B illustrates standby time Ts in accordance with the exemplary embodiment.

FIG. 8 shows an example of a coding table used for the plasma display apparatus in accordance with the exemplary embodiment.

FIG. 9 shows another example of a coding table used for the plasma display apparatus in accordance with the exemplary embodiment.

### DESCRIPTION OF EMBODIMENTS

Hereinafter, a plasma display apparatus in accordance with an exemplary embodiment of the present invention is described, with reference to the accompanying drawings.

### Exemplary Embodiment

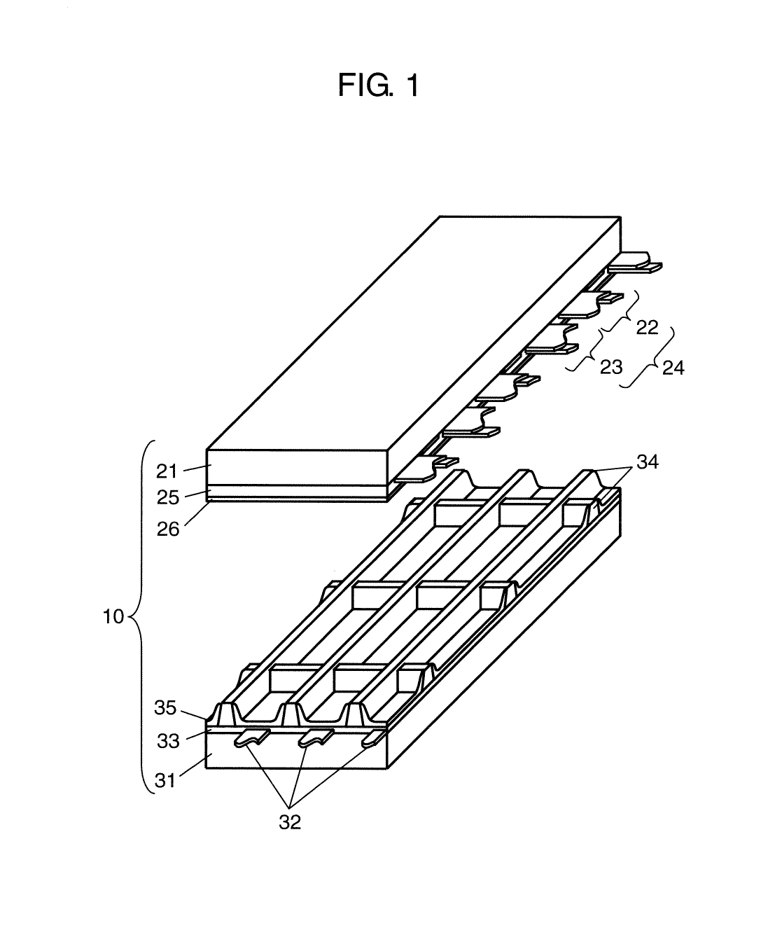

FIG. 1 is an exploded perspective view showing a structure of panel 10 for use in a plasma display apparatus in accordance with an exemplary embodiment of the present invention. On glass-made front substrate 21, a plurality of display electrode pairs, each including scan electrode 22 and sustain electrode 23, horizontally extends in a parallel arrangement. Dielectric layer 25 is formed so as to cover scan electrodes 22 and sustain electrodes 23. Protective layer 26 is formed over dielectric layer 25.

Protective layer 26 is made of a material predominantly composed of magnesium oxide (MgO). The material is proven as being effective in decreasing a discharge start voltage in the discharge cells. Besides, the MgO-based material offers a large coefficient of secondary electron emission and high durability against discharge gas having neon (Ne) and xenon (Xe).

On glass-made rear substrate 31, a plurality of data electrodes 32 extends vertically. Dielectric layer 33 is formed so as to cover data electrodes 32, and grid-like barrier ribs 34 are formed on the dielectric layer. On the side faces of barrier ribs 34 and on dielectric layer 33, phosphor layers 35 for emitting light of red color (R), green color (G), and blue color (B) are formed.

Front substrate 21 and rear substrate 31 face each other such that display electrode pairs 24 intersect data electrodes 32 with a small discharge space sandwiched between the electrodes. The outer peripheries of the substrates are sealed with a sealing material, such as a glass frit. The inside of the discharge space is filled with discharge gas. For example, the gas is a mixture gas of neon and xenon having a xenon partial pressure of approximately 10%.

Barrier ribs 34 divide the discharge space into a plurality of compartments in a way that each compartment has the intersecting part of display electrode pair 24 and data electrode 32. Discharge cells are thus formed in the intersecting parts of display electrode pairs 24 and data electrodes 32.

The discharge cells have a discharge and emit light (light on) so as to display a color image on panel 10.

In panel 10, one pixel is formed by three successive discharge cells arranged in the extending direction of display electrode pair 24, i.e. a discharge cell for emitting light of red color (R), a discharge cell for emitting light of green color (G), and a discharge cell for emitting light of blue (B) color. Hereinafter, a discharge cell that emits red light is referred to as an R discharge cell, a discharge cell that emits green light is referred to as a G discharge cell, and a discharge cell that emits blue light is referred to as a B discharge cell.

The structure of panel 10 is not limited to the above, and may include barrier ribs in a stripe pattern, for example. The mixture ratio of the discharge gas is not limited to the above numerical value, and other mixture ratios may be used. For example, the xenon partial pressure may be increased for enhancing emission efficiency.

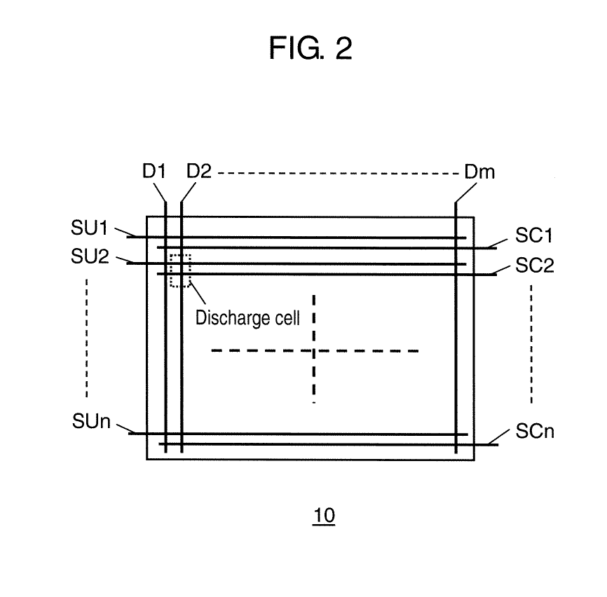

FIG. 2 is an electrode array diagram of panel 10 for use in the plasma display apparatus in accordance with the exemplary embodiment of the present invention. Panel 10 has n scan electrodes SC1 through SCn (that form scan electrodes 22 in FIG. 1) and n sustain electrodes SU1 through SUn (that form sustain electrodes 23 in FIG. 1) both long in the horizontal (row) direction, and m data electrodes D1 through Dm (that form data electrodes 32 in FIG. 1) long in the vertical (line) direction. A discharge cell is formed in the part where a pair of scan electrode SCi (i=1 to n) and sustain electrode SUi intersects one data electrode Dj (j=1 to m). That is, m discharge cells (i.e. m/3 pixels) are formed for each display electrode pair 24. In the discharge space, m×n discharge cells are formed. The area having m×n discharge cells is the image display area of panel 10. For example, in a panel having 1920×1080 pixels, m=1920×3 and n=1080. Although n=1080 in the embodiment, it is not to be construed as limiting value.

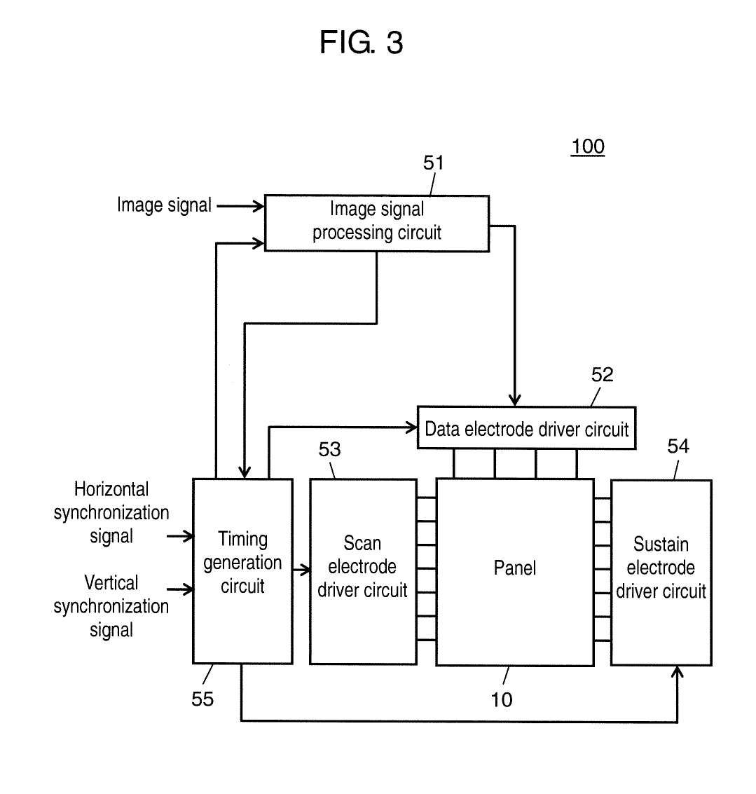

FIG. 3 is a circuit block diagram of plasma display apparatus 100 in accordance with the exemplary embodiment. Plasma display apparatus 100 has panel 10 and a driver circuit. The driver circuit includes image signal processing circuit 51, data electrode driver circuit 52, scan electrode driver circuit 53, sustain electrode driver circuit 54, timing generation circuit 55, and electric power supply circuits (not shown) for supplying electric power necessary for each circuit block.

Image signal processing circuit 51 allocates gradation values to each discharge cell, based on an input image signal. The image signal processing circuit converts the gradation values into image data representing light emission and no light emission (where, light emission and no light emission correspond to ‘1’ and ‘0’, respectively, of digital signals) in each subfield. That is, image signal processing circuit 51 converts the image signal for one field into image data representing light emission and no light emission in each subfield. For instance, when the input image signal includes R signal, G signal, and B signal, R, G, and B gradation values are allocated to the respective discharge cells, based on the R signal, G signal, and B signal. When the input image signal includes luminance signal (Y signal) and chroma signal (C signal, R-Y signal and B-Y signal, u signal and v signal, or the like), the R signal, the G signal, and the B signal are calculated based on the luminance signal and the chroma signal, and thereafter the R, G, and B gradation values (gradation values represented in one field) are allocated to the respective discharge cells. Then, the R, G, and B gradation values allocated to the respective discharge cells are converted into image data representing light emission and no light emission in each subfield.

Timing generation circuit 55 generates timing signals for controlling the operation of each circuit block, based on a horizontal synchronization signal and a vertical synchronization signal, and supplies the generated timing signals to respective circuit blocks (e.g. data electrode driver circuit 52, scan electrode driver circuit 53, sustain electrode driver circuit 54, and image signal processing circuit 51).

Scan electrode driver circuit 53 has an initializing waveform generation circuit, a sustain pulse generation circuit, and a scan pulse generation circuit (not shown in FIG. 3). Scan electrode driver circuit 53 generates driving voltage waveforms based on the timing signals fed from timing generation circuit 55, and applies the voltage waveforms to scan electrodes SC1 through SCn. In response to the control signals, the initializing waveform generation circuit generates an initializing waveform to be applied to scan electrodes SC1 through SCn in the initializing periods. In response to the timing signals, the sustain pulse generation circuit generates sustain pulses to be applied to scan electrodes SC1 through SCn in the sustain periods. The scan pulse generation circuit has a plurality of scan electrode driver ICs (scan ICs), and in response to the control signals, the scan pulse generation circuit generates scan pulses to be applied to scan electrodes SC1 through SCn in the address periods.

Sustain electrode driver circuit 54 has a sustain pulse generation circuit, and a circuit for generating voltage Ve1 and voltage Ve2 (not shown in FIG. 3). In response to the timing signals supplied from timing generation circuit 55, sustain electrode driver circuit 54 generates driving voltage waveforms and applies them to sustain electrodes SU1 through SUn. In the sustain period, sustain electrode driver circuit 54 generates sustain pulses in response to the timing signals and applies the sustain pulses to sustain electrodes SU1 through SUn.

Data electrode driver circuit 52 converts data forming image data for each subfield into signals corresponding to each of data electrodes D1 through Dm. Based on the converted signal and the timing signals fed from timing generation circuit 55, data electrode driver circuit 52 drives data electrodes D1 through Dm. In the address period, data electrode driver circuit 52 generates address pulses and applies them to data electrodes D1 through Dm.

Next, the method for driving panel 10 of the plasma display apparatus of the exemplary embodiment. The plasma display apparatus of the embodiment display gradations by a subfield method. In the subfield method, one field is divided into a plurality of subfields along a temporal axis, and a luminance weight is set for each subfield. Each of the subfields has an initializing period, an address period, and a sustain period. By controlling the light emission and no light emission in each discharge cell in each subfield, an image is displayed on panel 10.

The luminance weight represents a ratio of the magnitudes of luminance displayed in the respective subfields. In the sustain period of each subfield, sustain pulses corresponding in number to the luminance weight are generated.

For example, the light emission in the subfield having the luminance weight “8” is approximately eight times as high as that in the subfield having the luminance weight “1”, and approximately four times as high as that in the subfield having the luminance weight “2”. Therefore, the selective light emission caused by the combination of the respective subfields in response to image signals allows the panel to display various gradations forming an image.

In this exemplary embodiment, one field is divided into 12 subfields (subfield SF1, subfield SF2, . . . , subfield SF12). Respective subfields have luminance weights of 1, 2, 8, 18, 30, 40, 2, 5, 11, 18, 30, and 40. According to the embodiment, as described above, the setting of the luminance weight of each subfield is not simply on ascending order; the luminance weight does not simply increase from subfield SF1 through subfield SF12. According to the structure of the embodiment, the luminance weight increases between subfield SF1 and subfield SF6 on an ascending order; meanwhile, the luminance weight increases between subfield SF7 and SF12 on an ascending order. The reason of the setting above will be described later.

In the initializing period, an initializing discharge is caused so as to form wall charge necessary for the subsequent address discharge on the respective electrodes. The initializing operation includes an all-cell initializing operation and a selective initializing operation. In the initializing period of one subfield among a plurality of subfields, an all-cell initializing operation for causing an initializing discharge in all the discharge cells is performed. In the initializing periods of the other subfields, a selective initializing operation for causing an initializing discharge only in the discharge cells having undergone a sustain discharge in the sustain period of the immediately preceding subfield is performed. Hereinafter, the subfield having the all-cell initializing operation is referred to as an all-cell initializing subfield, while the subfield having the selective initializing operation is referred to as a selective initializing subfield.

In the embodiment, the description will be given on a case where subfield SF1 is the all-cell initializing subfield, and subfields SF2 through SF12 are the selective initializing subfields. With the structure above, the light emission with no contribution to image display is only the light emission caused by the discharge in the all-cell initializing operation in subfield SF1. That is, the display area of luminance of black where luminance of black is displayed due to no sustain discharge has only weak light emission caused by the all-cell initializing operation. Thereby, an image of high contrast can be displayed on panel 10.

In the address period of each subfield, an address discharge is generated selectively in a discharge cell to be lit, and wall charge for generating a sustain discharge in the next sustain period is formed in the discharge cell.

In the sustain period of each subfield, sustain pulses based on the luminance weight of the corresponding subfield multiplied by a predetermined proportionality factor are applied to respective display electrode pairs 24. This proportionality factor is a luminance magnification. The application of the sustain pulses generates a sustain discharge in the discharge cell having undergone an address discharge in the immediately preceding address period, providing the discharge cell with light emission.

In each sustain period, sustain pulses equal in number to the luminance weight of the corresponding subfield multiplied by a predetermined luminance magnification are applied to respective scan electrodes 22 and sustain electrodes 23. Therefore, when the luminance magnification is 2, in the sustain period of a subfield having a luminance weight of 2, each of scan electrode 22 and sustain electrode 23 undergoes four-time application of sustain pulses. That is, the number of sustain pulses generated in the sustain period of the subfield is 8.

However, in this exemplary embodiment, the number of subfields forming one field, or the luminance weights of the respective subfields is not limited to the above values. Alternatively, the subfield structure may be switched in response to an image signal, for example.

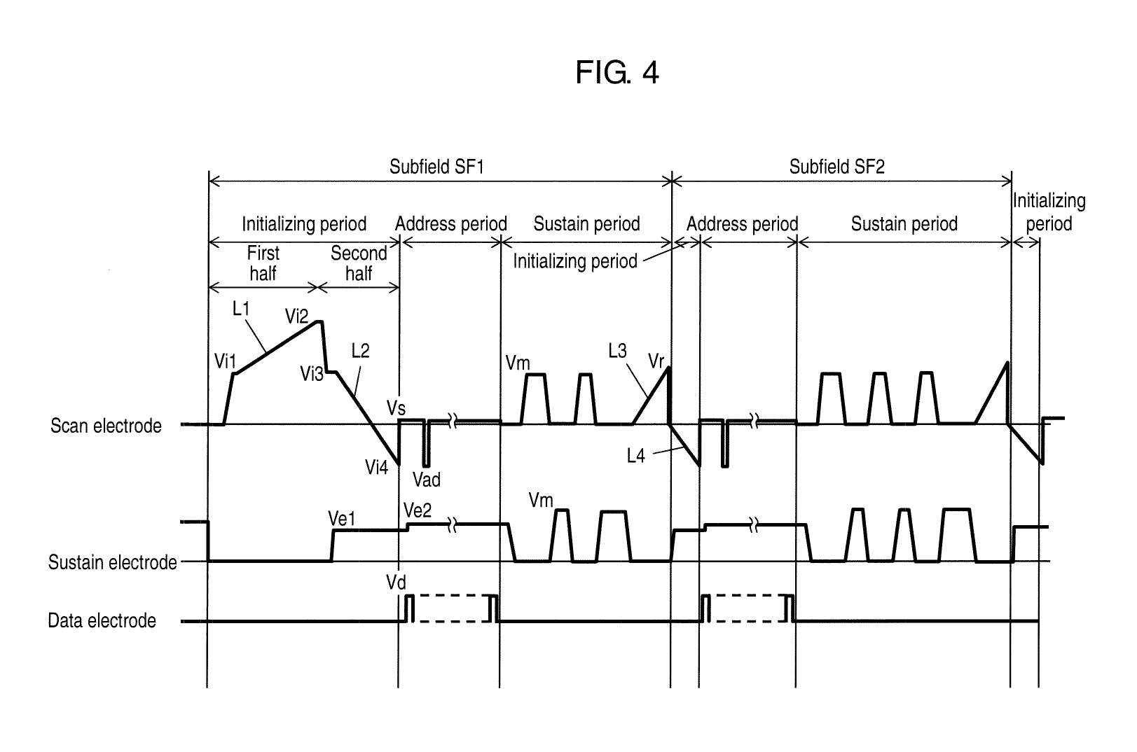

FIG. 4 is a chart of driving voltage waveforms applied to the respective electrodes of panel 10 for use in the plasma display apparatus in accordance with the exemplary embodiment of the present invention. FIG. 4 shows driving voltage waveforms applied to scan electrodes 22, sustain electrodes 23, and data electrodes 32.

It will also be noted that the driving voltage waveforms applied to scan electrodes 22 in the initializing period are different between the two subfields shown in FIG. 4. In the two subfields, one is subfield SF1 as an all-cell initializing subfield, and the other is subfield SF2 as a selective initializing subfield.

The driving voltage waveforms used for other subfields is similar to that of subfield SF2 except for the number of sustain pulses. Scan electrode SCi, sustain electrode SUi, and data electrode Dk in the following description are the electrodes selected from the respective electrodes, based on image data (i.e., data representing the light emission and no light emission in each subfield).

First, a description is provided for subfield SF1 as the all-cell initializing subfield.

In the first half of the initializing period of subfield SF1, 0 (V) is applied to data electrodes D1 through Dm, and sustain electrodes SU1 through SUn. Voltage Vi1 is applied to scan electrodes SC1 through SCn. Voltage Vi1 is set to a voltage lower than a discharge start voltage with respect to sustain electrodes SU1 through SUn. Further, a ramp voltage gently rising from voltage Vi1 toward voltage Vi2 is applied to scan electrodes SC1 through SCn. Hereinafter, the ramp voltage is referred to as ramp voltage L1. Voltage Vi2 is set to a voltage exceeding the discharge start voltage with respect to sustain electrodes SU1 through SUn. For example, the voltage gradient of ramp voltage L1 may be set to approximately 1.3V/μsec.

While ramp voltage L1 is rising, a weak initializing discharge continuously occurs between scan electrodes SC1 through SCn and sustain electrodes SU1 through SUn, and between scan electrodes SC1 through SCn and data electrodes D1 through Dm. Through the discharge, negative wall voltage accumulates on scan electrodes SC1 through SCn, and positive wall voltage accumulates on data electrodes D1 through Dm and sustain electrodes SU1 through SUn. This wall voltage on the electrodes means voltages that are generated by the wall charge accumulated on the dielectric layers covering the electrodes, the protective layer, the phosphor layers, or the like.

In the second half of the initializing period, positive voltage Ve1 is applied to sustain electrodes SU1 through SUn, and 0 (V) is applied to data electrodes D1 through Dm. A ramp voltage gently falling from voltage Vi3 to negative voltage Vi4 is applied to scan electrodes SC1 through SCn. Hereinafter, the ramp voltage is referred to as ramp voltage L2. Voltage Vi3 is set to a voltage lower than the discharge start voltage with respect to sustain electrodes SU1 through SUn, and voltage Vi4 is set to a voltage exceeding the discharge start voltage. For example, the voltage gradient of ramp voltage L2 may be set to approximately −2.5V/μsec.

While ramp voltage L2 is applied to scan electrodes SC1 through SCn, a weak initializing discharge occurs between scan electrodes SC1 through SCn and sustain electrodes SU1 through SUn, and between scan electrodes SC1 through SCn and data electrodes D1 through Dm. This weak discharge reduces the negative wall voltage on scan electrodes SC1 through SCn and the positive wall voltage on sustain electrodes SU1 through SUn, and adjusts the positive wall voltage on data electrodes D1 through Dm to a value appropriate for the address operation. In this manner, the all-cell initializing operation for causing an initializing discharge in all the discharge cells is completed.

Hereinafter, the period having an all-cell initializing operation is referred to as an all-cell initializing period; similarly, the driving voltage waveform for causing an all-cell initializing operation is referred to as an all-cell initializing waveform.

In the subsequent address period, voltage Ve2 is applied to sustain electrodes SU1 through SUn, and voltage Vs is applied to scan electrodes SC1 through SCn.

Next, a scan pulse of negative voltage Vad is applied to scan electrode SC1 in the first row that firstly undergoes the address operation. At the same time, an address pulse of positive voltage Vd is applied to data electrode Dk of a discharge cell to be lit in the first row in data electrodes D1 through Dm.

Through the application of the address pulse of voltage Vd, the voltage difference in the intersecting part of data electrode Dk and scan electrode SC1 is calculated by adding the difference between the wall voltage on data electrode Dk and the wall voltage on scan electrode SC1 to the externally applied voltage difference (=voltage Vd-voltage Vad). In this way, the voltage difference between data electrode Dk and scan electrode SC1 exceeds the discharge start voltage, generating a discharge between the two electrodes above.

As described above, voltage Ve2 is applied to sustain electrodes SU1 through SUn. Through the application of the voltage, the voltage difference between sustain electrode SU1 and scan electrode SC1 is calculated by adding the difference between the wall voltage on sustain electrode SU1 and the wall voltage on scan electrode SC1 to the externally applied voltage difference (=voltage Ve2−voltage Vad). At this time, by setting voltage Ve2 at a voltage value just below the discharge start voltage, a “discharge-prone” state just before an actual discharge generation is given between sustain electrode SU1 and scan electrode SC1.

The discharge occurred between data electrode Dk and scan electrode SC1 triggers a discharge between sustain electrode SU1 and scan electrode SC1 that are disposed in the area intersecting to data electrode Dk. Thus, an address discharge occurs in the discharge cell to be lit. Positive wall voltage accumulates on scan electrode SC1, and negative wall voltage accumulates on sustain electrode SU1 and on data electrode Dk.

In this manner, address operation is performed to cause an address discharge in the discharge cells to be lit in the first row and to accumulate wall voltage on the respective electrodes. On the other hand, because of no application of address pulses, the voltage of the intersecting part of scan electrode SC1 and data electrodes 32 does not exceed the discharge start voltage; accordingly, no address discharge occurs.

Next, a scan pulse of voltage Vad is applied to scan electrode SC2 in the second row. At the same time, an address pulse of positive voltage Vd is applied to data electrode Dk of a discharge cell to be lit in the second row. In a discharge cell to which a scan pulse and an address pulse are simultaneously applied, the voltage difference in the intersecting part of data electrode Dk and scan electrode SC2 exceeds the discharge start voltage. In this manner, address operation is performed to cause an address discharge in the discharge cells to be lit in the second row and to accumulate wall voltage on the respective electrodes.

In a similar way, the address operation is performed in the order of scan electrode SC3, scan electrode SC4, . . . , scan electrode SCn in the n-th row. On the completion of the address operation on the discharge cells in the n-th row, the address period is over. In the address period, as described above, an address discharge is selectively generated in a discharge cell to be lit, and wall charge is formed in the discharge cell.

In the subsequent sustain period, voltage 0 (V) is applied to sustain electrodes SU1 through SUn, and at the same time, sustain pulses of positive voltage Vm are applied to scan electrodes SC1 through SCn. In the discharge cells having undergone the address discharge, the voltage difference between scan electrode SCi and sustain electrode SUi is calculated by adding the difference between the wall voltage on scan electrode SCi and the wall voltage on sustain electrode SUi to sustain pulse voltage Vm.

Thus, the voltage difference between scan electrode SCi and sustain electrode SUi exceeds the discharge start voltage and a sustain discharge occurs between scan electrode SCi and sustain electrode SUi. Ultraviolet rays generated by this discharge cause phosphor layers 35 to emit light. With this discharge, negative wall voltage accumulates on scan electrode SCi, and positive wall voltage accumulates on sustain electrode SUi. Positive wall voltage also accumulates on data electrode Dk. In the discharge cells having undergone no address discharge in the address period, no sustain discharge occurs and the wall voltage at the completion of the initializing period is maintained.

Subsequently, voltage 0 (V) is applied to scan electrodes SC1 through SCn, and sustain pulses of voltage Vm are applied to sustain electrodes SU1 through SUn. In the discharge cells having undergone the sustain discharge, the voltage difference between sustain electrode SUi and scan electrode SCi exceeds the discharge start voltage. Thereby, a sustain discharge occurs again between sustain electrode SUi and scan electrode SCi. Negative wall voltage accumulates on sustain electrode SUi, and positive wall voltage accumulates on scan electrode SCi.

Similarly, sustain pulses are alternately applied to scan electrodes SC1 through SCn and sustain electrodes SU1 through SUn. The number of sustain pulses applied to the electrodes above corresponds to a number calculated by multiplying the luminance weight by a predetermined luminance magnification. The potential difference applied between display electrode pairs 24 continuously generates a sustain discharge in the discharge cells having undergone the address discharge in the address period.

After the sustain pulses have been generated in the sustain period (i.e., at the end of the sustain period), a ramp waveform voltage gently rising from 0 (V) as the base electric potential toward voltage Vr is applied to scan electrodes SC1 through SCn while 0 (V) is applied to sustain electrodes SU1 through SUn and data electrodes D1 through Dm. Voltage Vr is set to be equivalent to the sustain pulses of voltage Vm or to be higher than it. The voltage gradient of the ramp waveform voltage at that time is, for example, approximately 10V/μsec, which is steeper than that of ramp voltage L1. Hereinafter, the ramp waveform voltage is referred to as erasing ramp voltage L3.

While erasing ramp voltage L3 (applied to scan electrodes SC1 through SCn) is increasing over the discharge start voltage, a weak discharge continuously occurs in a discharge cell having undergone a sustain discharge. Charged particles generated by this weak discharge accumulate as wall charge on sustain electrode SUi and scan electrode SCi so as to reduce the voltage difference between sustain electrode SUi and scan electrode SCi. Thereby, in the discharge cells having undergone the sustain discharge, the wall voltage on scan electrode SCi and sustain electrode SUi is weakened, while the positive wall voltage is left on data electrode Dk.

After the rising voltage applied to scan electrodes SC1 through SCn has reached voltage Vr, the voltage is lowered to voltage 0 (V). Thus, the sustain operation in the sustain period is completed.

The driving operation of subfield SF1 is thus completed.

In the initializing period of subfield SF2, a selective initializing operation is performed. The driving voltage waveform used in the initializing period differs from that used in subfield SF1 in that the first half of the waveform is omitted. In the initializing period of subfield SF2, voltage Ve1 is applied to sustain electrodes SU1 through SUn, and 0 (V) is applied to data electrodes D1 through Dm. A ramp waveform voltage, which is referred to as ramp voltage L4, is applied to scan electrodes SC1 through SCn. Ramp voltage L4 gently falls from voltage Vi3′ (e.g. voltage 0 (V)) lower than the discharge start voltage (with respect to sustain electrodes SU1 through SUn) toward negative voltage Vi4 exceeding the discharge start voltage. The voltage gradient of ramp voltage L4 is, for example, approximately −2.5V/μsec, which is the same as that of ramp voltage L2.

With the application of voltage, a weak initializing discharge occurs in the discharge cells having undergone a sustain discharge in the sustain period of the immediately preceding subfield (i.e. subfield SF1 in FIG. 4). This weak discharge reduces the wall voltage on scan electrode SCi and sustain electrode SUi. Since sufficient positive wall voltage is accumulated on data electrode Dk by the immediately preceding sustain discharge, an excess amount of this wall voltage is discharged and is adjusted to a value appropriately for the address operation.

In contrast, in the discharge cells having undergone no sustain discharge in the sustain period of the immediately preceding subfield (i.e. subfield SF1 in FIG. 4), no initializing discharge occurs, and the wall charge at the completion of the initializing period of the immediately preceding subfield is maintained.

In this manner, in the initializing period of subfield SF2, a selective initializing operation is performed so as to selectively cause an initializing discharge in the discharge cells having undergone a sustain discharge in the sustain period of the immediately preceding subfield. Hereinafter, the period having a selective initializing operation is referred to as a selective initializing period; similarly, the driving voltage waveform for causing a selective initializing operation is referred to as a selective initializing waveform.

The initializing waveform generation circuit of scan electrode driver circuit 53 generates the all-cell initializing waveform and the selective initializing waveform to be applied to scan electrodes 22.

The driving voltage waveforms applied to each electrode in the address period and the sustain period of subfield SF2 are nearly the same as those used in the address period and the sustain period of subfield SF1, except for the number of the sustain pulses. Further, the driving voltage waveforms applied to each electrode in other subfields after subfield SF3 are nearly the same as those used in subfield SF2, except for the number of the sustain pulses.

The description above has provided an overview of the driving voltage waveforms applied to the electrodes of panel 10 of the embodiment.

Next, the subfield structure of one field for driving the plasma display apparatus of the embodiment will be described.

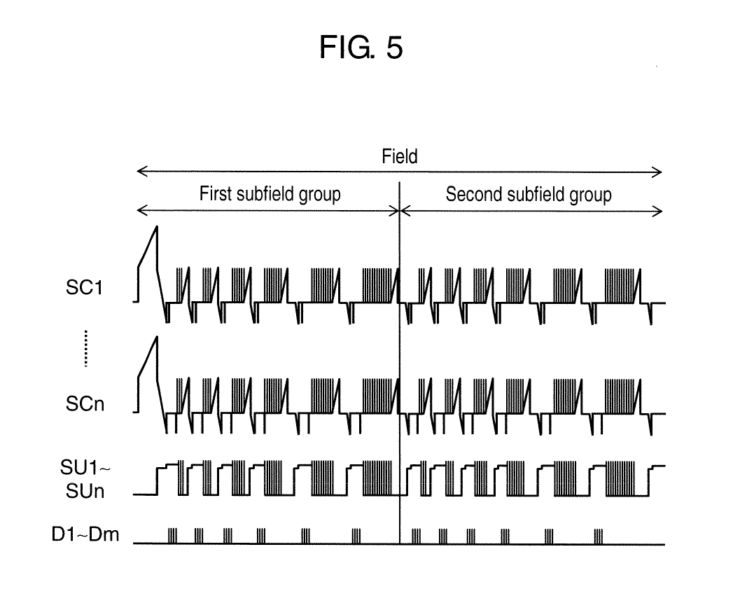

FIG. 5 schematically shows driving voltage waveforms applied in one field to respective electrodes of the panel used for the plasma display apparatus in accordance with the exemplary embodiment.

According to the embodiment, one field has a first subfield group and a second subfield group temporally successive to the first subfield group. Each of the first subfield group and the second subfield group is formed of a plurality of temporally successive subfields. At the same time, the luminance weight is determined to each subfield so as to satisfy the following
the luminance weight increases in the order of occurrence of the subfields; and
the first subfield of the second subfield group has a luminance weight smaller than that of the last subfield of the first subfield group.

For example, one field is divided into 12 subfields (subfield SF1, subfield SF2, . . . , subfield SF12), and each subfield has the following luminance weight: 1, 2, 8, 18, 30, 40, 2, 5, 11, 18, 30, and 40.

One field is formed of two subfield groups: subfields SF1 through SF6 belong to the first subfield group; and subfields SF 7 through SF12 belong to the second subfield group. In the first subfield group, the luminance weight increases between subfield SF1 and subfield SF6; meanwhile, in the second subfield group, the luminance weight increases between subfield SF7 and subfield SF12. Subfield SF7, which is the first subfield of the second subfield group, has a luminance weight smaller than that of subfield SF6 as the last subfield of the first subfield group.

According to the embodiment, as described above, the luminance weight does not increase in a simple ascending order from subfield SF1 to subfield SF12. The luminance weight is determined to increase in the ascending order within the first subfield group. The luminance weight of the first subfield of the second subfield group (i.e. subfield SF7) is determined to be smaller than that of the last subfield of the first subfield group (i.e. subfield SF6). In the second subfield group, the luminance weight is determined to increase in the ascending order from the value of the luminance weight of subfield SF7.

According to the embodiment, the following is the structural feature of the subfields forming one field. That is, the luminance weight increases in the order of occurrence of subfields in each subfield group on the condition that the luminance weight is set to be low at change of the subfield group.

When the luminance weight of each subfield is determined to simply increase in the ascending order throughout one field, the subfields with high luminance weight are concentrated in the last half of one field. In such a structure, when image signals with low field frequency (i.e. the number of fields per sec), for example, PAL image signals with 50 fields/sec, are displayed on the panel, image flickering known as flicker occurs. According to the subfield structure of the embodiment, in contrast, the subfields with high luminance weight disperse in the field. The structure of the embodiment suppresses the inconvenient phenomenon.

The number of subfields forming one field, the luminance weight for each subfield, and the number of subfields forming the first and the second subfield groups are not limited to the numerical values introduced in the description above. The structure of each subfield may be determined appropriately for the specifications of a plasma display apparatus, for example.

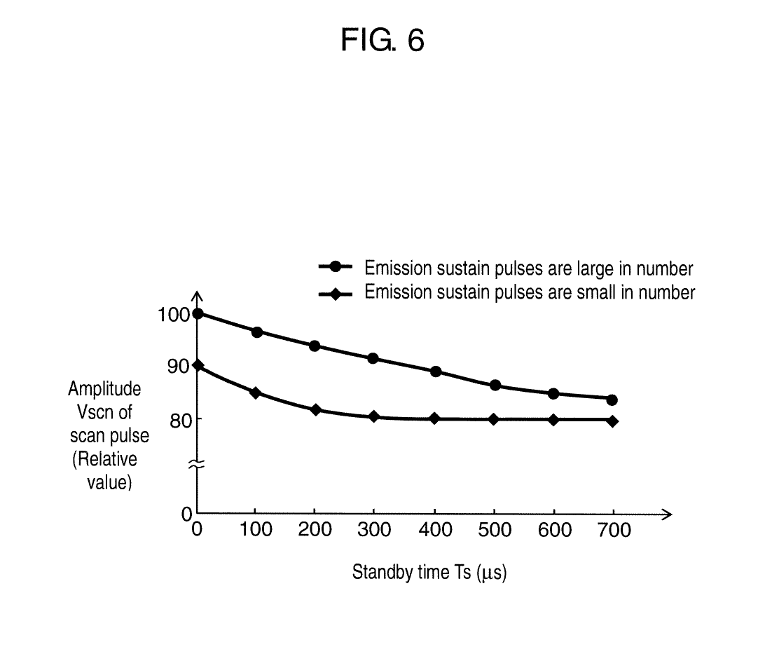

FIG. 6 is a graph showing the relation between an amplitude of scan pulses and a length of standby time Ts for generating a stable address discharge in panel 10 used for the plasma display apparatus in accordance with the exemplary embodiment.

Standby time Ts is the time interval between the address period as a measurement target and the sustain pulse that has caused the last sustain discharge in the sustain period of the subfield previous to the aforementioned address period. The amplitude of scan pulses is a voltage difference between voltage Vs and voltage Vad. Hereinafter, the amplitude of a scan pulse is referred to as amplitude Vscn. That is, amplitude Vscn=voltage Vs−voltage Vad.

In FIG. 6, the vertical axis of the graph represents amplitude Vscn of scan pulses necessary for stable address operation in the address period, and the horizontal axis represents standby time Ts. FIG. 6 shows the measurement result of amplitude Vscn of scan pulses necessary for stable address operation, with standby time Ts changed.

Hereinafter, the sustain pulses for causing sustain discharge in the sustain period are referred to as emission sustain pulses. In the description, the emission sustain pulses are distinguished from sustain pulses for causing no sustain discharge (i.e., sustain pulses applied to the discharge cells having undergone no address discharge).

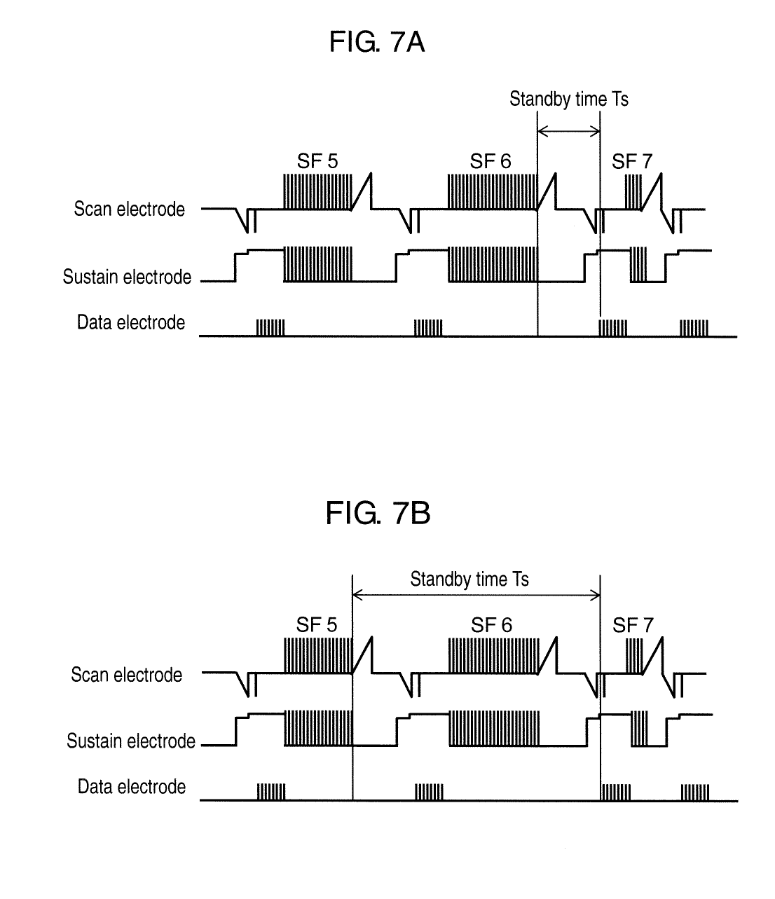

Standby time Ts will be described with reference to FIGS. 7A and 7B.

FIGS. 7A and 7B illustrate standby time Ts in accordance with the exemplary embodiment of the present invention. Specifically, FIG. 7A shows standby time Ts in a case where a sustain discharge is generated in the sustain period of subfield SF6 and a corresponding discharge cell emits light. FIG. 7B shows standby time Ts in a case where a sustain discharge is generated in the sustain period of subfield SF5 and a corresponding discharge cell emits light, whereas no sustain discharge is generated in the sustain period of subfield SF6 and accordingly no light emission of a corresponding discharge cell.

For example, when a sustain discharge is generated in the sustain period of subfield SF6, as shown in FIG. 7A, standby time Ts is the period of time from the last sustain pulse in the sustain period of subfield SF6 until the start of the address period (i.e. until the first scan pulse is generated) in subfield SF7.

In the case of FIG. 7B, that is, when the sustain period of subfield SF5 has a sustain discharge and accordingly has light emission of corresponding discharge cells, while the sustain period of subfield SF6 has no sustain discharge and accordingly no light emission of the discharge cells, standby time Ts is the period of time from the last sustain pulse in the sustain period of subfield SF5 until the start of the address period (i.e. until the first scan pulse is generated) in subfield SF7.

FIG. 6 shows the measurement result of amplitude Vscn of scan pulses necessary for generating stable address discharge, with standby time Ts changed, on the following two conditions: on the condition that the emission sustain pulses are large in number (e.g. the number of emission sustain pulses: 200) and on the condition that the emission sustain pulses are small in number (e.g. the number of emission sustain pulses: 100).

As is apparent from FIG. 6, compared to the case where the emission sustain pulses are small in number, amplitude Vscn of scan pulses necessary for stable address operation increases when the emission sustain pulses are large in number. It is considered that floating electrons generated by a sustain discharge reduce wall charge in the discharge cell. That is, the larger in number the sustain discharges occur, the larger in number the floating electrons are generated. Therefore, the wall charge in the discharge cell is further reduced.

It is also apparent from FIG. 6 that increase in standby time Ts reduces amplitude Vscn of scan pulses necessary for obtaining stable address discharge. It is considered that increase in standby time Ts lessens the effect on wall charge by the floating electrons generated by a sustain discharge.

Besides, when the emission sustain pulses are small in number, the effect of decreasing amplitude Vscn of scan pulses necessary for stable address discharge reaches “saturation” in relatively short standby time Ts. In contrast, when the emission sustain pulses are large in number, standby time Ts for the effect to get saturation is longer than the case where the emission sustain pulses are small in number.

According to the embodiment, subfield SF6 as the last subfield of the first subfield group has luminance weight of 40, the greatest value in one field. Accordingly, the sustain period of subfield SF6 has the greatest number of sustain pulses in one field. Therefore, when light emission caused by the sustain discharge occurs not only in the sustain period of subfield SF6 but also in subfield SF7 as the first subfield of the second subfield group, extending standby time Ts between subfield SF6 and subfield SF7 (i.e. the period of time from the last sustain pulse in the sustain period of subfield SF6 to the first scan pulse in the address period of subfield SF7) contributes to stable address discharge in the address period of subfield SF7. The measurement result of FIG. 6 apparently shows above.

Next, a method for obtaining light emission of discharge cells with luminance suitable for a gradation level will be described. In the description below, the wording of “emitting a discharge cell with luminance suitable for a gradation level” may be expressed by the wording of “displaying gradation”.

In the embodiment, as described above, one field is formed of a plurality of subfields each of which having a predetermined luminance weight. Out of a plurality of different combinations of subfields with light emission and subfields with no light emission, two-or-more sets for display for displaying gradation are selected to make “combination sets for display”. Hereinafter, combination of a subfield with light emission and a subfield with no light emission is referred to as “coding”, combination used for displaying gradation (combination for display) is referred to as “coding for display”, and a set of combination for display is referred to as a “coding table”.

To display gradation on panel 10, one coding for display is selected from the coding table according to image signals, and light emission/no light emission of discharge cells is controlled for each subfield with reference to the selected coding for display.

Next, the coding table used in the embodiment will be described. Hereinafter, for the sake of simplicity, the gradation for displaying black is represented as gradation 0 and the gradation corresponding to luminance weight N is represented as gradation N. For example, the gradation of a discharge cell in which only subfield SF1 with luminance weight 1 emits light is represented as gradation 1. The gradation of a discharge cell in which subfield SF1 with luminance weight 1 and subfield SF2 with luminance weight 2 emit light is represented as gradation 3.

According to the embodiment, a gradation having a level higher than a gradation threshold is displayed by preparing a set of combination for display (i.e. a coding table) such that the first subfield of the second subfield group has no light emission. An example of the coding table of the embodiment will be described below.

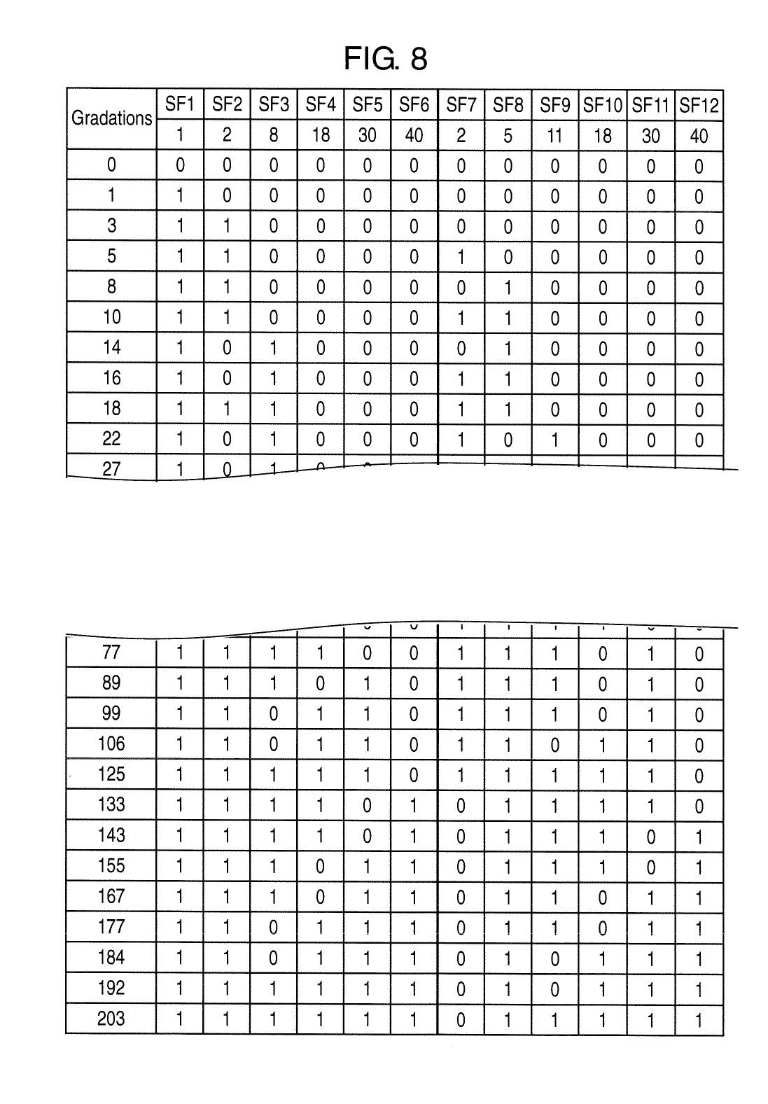

FIG. 8 shows a coding table used for the plasma display apparatus in accordance with the exemplary embodiment. In the coding table of FIG. 8, “0” represents no light emission, and “1” represents light emission.

Image signal processing circuit 51 shown in FIG. 3 has, for example, the coding table shown in FIG. 8. According to image signals, image signal processing circuit 51 selects one coding for display from the coding table, and controls light emission/no light emission of discharge cells for each subfield for displaying gradation on panel 10.

Specifically, receiving red image signal, green image signal, and blue image signal, image signal processing circuit 51 converts them into red image data, green image data, and blue image data, for example, based on the coding table shown in FIG. 8. In the image data for each color, light emission and no light emission of each subfield correspond to 1 and 0, respectively.

Suppose that an image is displayed by using the coding table of FIG. 8. In a discharge cell that displays gradation 1, the address operation is performed in only subfield SF1 with luminance weight 1, and other subfields have no address operation. The discharge cell with gradation 1 undergoes sustain discharge corresponding in number to luminance weight 1, displaying gradation 1.

In a discharge cell that displays gradation 3, the address operation is performed in subfield SF1 with luminance weight 1 and in subfield SF2 with luminance weight 2 for emitting light. In the discharge cell, sustain discharge corresponding in number to luminance weight 1 is generated in the sustain period of subfield SF1 and sustain discharge corresponding in number to luminance weight 2 is generated in the sustain period of subfield SF2. As a result, the discharge cell displays gradation 3.

In a discharge cell that displays gradation 0 (i.e. a discharge cell for displaying black), no address operation is performed throughout the field (from subfield SF1 to subfield SF12). No sustain discharge in the field allows the discharge cell to have the lowest luminance.

In a discharge cell that displays gradation 5, the address operation is performed in subfield SF1 and subfield SF2 of the first subfield group, and is also performed in subfield SF7 of the second subfield group. In a discharge cell that displays gradation 10, the address operation is performed in subfield SF1 and subfield SF2 of the first subfield group, and is also performed in subfield SF7 and subfield SF8 of the second subfield group. In this way, to display gradation N, whether a subfield has address operation or not is determined by the coding table of FIG. 8.

According to the embodiment, the gradation threshold of the coding table shown in FIG. 8 is determined to gradation 133. Therefore, when a discharge cell displays gradation 133 or higher, subfield SF7, which is the first subfield of the second subfield group and has the smallest luminance weight in the second subfield group, has no light emission.

That is, in a discharge cell where subfield SF6 has light emission, subfield SF7 has no light emission.

As is described earlier, subfield SF6 is the last subfield with the greatest luminance weight in the first subfield group.

As is described in FIG. 6, to obtain a stable address operation in the address period successive to the sustain period where a large number of emission sustain pulses are generated, standby time Ts should preferably be kept long. In a discharge cell where subfield SF6 has light emission, determining subfield SF7 to have no light emission allows standby time Ts to be lengthened by a period corresponding to subfield SF7.

According to the light-emission control of subfields based on the coding table of FIG. 8, in a discharge cell where subfield SF6, which is last subfield with the greatest luminance weight in the first subfield group, has light emission, subfield SF7 as the first subfield in the second subfield group has no light emission. Through the control above, the address operation is performed in the address period of subfield SF8 after sufficiently long standby time Ts including the period corresponding to subfield SF7. Such an extended standby time contributes to decrease in amplitude Vscn of scan pulses necessary for generating stable address discharge, providing stable address operation in the address period of subfield SF8.

According to the coding table of FIG. 8, in a discharge cell that displays gradation lower than gradation 133 (, specifically, gradation 125 or less), whether subfield SF7 has light emission or not is determined so as to be suitable for the level of gradation. When an image having a large tone gap between gradation levels is displayed on the panel, an intensified “noise” has often been perceived to the eye. However, by virtue of light emission/no light emission control of subfield SF7, a sufficient number of gradation levels can be displayed on panel 10 even on a gradation level lower than gradation 125. In this way, the control decreases the noisy feeling on display image caused by a tone gap between gradation levels, allowing panel 10 to have good image display.

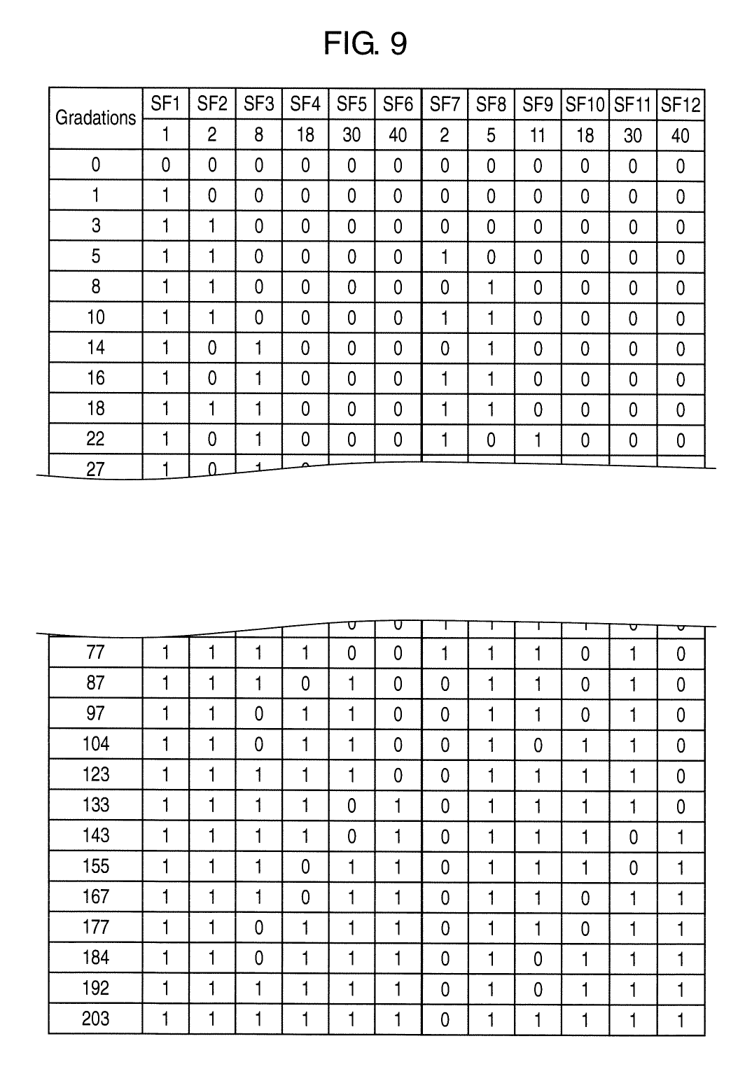

FIG. 9 shows another example of the coding table used for the plasma display apparatus in accordance with the exemplary embodiment. In the coding table of FIG. 9, too, “0” represents no light emission, and “1” represents light emission.

Like the coding table of FIG. 8, the coding table of FIG. 9 is determined on the following:
One field is formed of two subfield groups, each group having six subfields, subfields SF1 through SF6 belong to the first subfield group; and subfields SF 7 through SF12 belong to the second subfield group;
the luminance weight increases between subfield SF1 and subfield SF6 in an ascending order within the first subfield group,; meanwhile, the luminance weight increases between subfield SF7 and subfield SF12 in an ascending order within the second subfield group; and
the first subfield of the second subfield group has a luminance weight smaller than that of the last subfield of the first subfield group. According to the embodiment, each subfield has the following luminance weight: 1, 2, 8, 18, 30, 40, 2, 5, 11, 18, 30, and 40.

Besides, in the embodiment, the gradation threshold of the coding table shown in FIG. 9 is determined to gradation 87. Therefore, according to the coding table of FIG. 9, when a discharge cell displays gradation 87 or higher, subfield SF7, which is the first subfield of the second subfield group and has the smallest luminance weight in the group, has no light emission.

That is, in a discharge cell where subfield SF5 or subfield SF6 has light emission, subfield SF7 has no light emission.

In the first subfield group, subfield SF6 has the greatest luminance weight, and subfield SF5 has the second greatest luminance weight. According to the light-emission control of subfields based on the coding table of FIG. 9, in a discharge cell where subfield SF5 or subfield SF6 has light emission, subfield SF7 has no light emission. This allows standby time Ts to be lengthened by the period corresponding to subfield SF7. Such an extended standby time contributes to decrease in amplitude Vscn of scan pulses necessary for generating stable address discharge, providing stable address operation in the address period of subfield SF8.

According to the coding table of FIG. 9, in a discharge cell that displays gradation lower than gradation 87 (, specifically, gradation 77 or less), whether subfield SF7 has light emission or not is determined so as to be suitable for the level of gradation. By virtue of light emission/no light emission control of subfield SF7, a sufficient number of gradation levels can be displayed on panel 10 even on a low gradation level, i.e., gradation 77 or less. In this way, the control decreases a noisy feeling on display image caused by a tone gap between gradation levels, allowing panel 10 to have good image display.

As described above, the light emission control of the subfields is performed as follows:
One field is formed of two subfield groups;
the luminance weight increases in the order of occurrence of the subfields (i.e. in an ascending order) within each subfield group; and
the first subfield of the second subfield group has a luminance weight smaller than that of the last subfield of the first subfield group.

When a discharge cell displays gradation higher than the gradation threshold, the first subfield of the second subfield group has no address operation and therefore no light emission.

The coding table of the embodiment, as is shown in each example of FIG. 8 and FIG. 9, has the gradation threshold in the gradation levels. When a discharge cell displays gradation higher than the gradation threshold, the light emission control of the subfields is performed, based on coding for display data where the first subfield with the smallest luminance weight in the second subfield group has no light emission.

For example, the coding table shown in FIG. 8 has the gradation threshold at a gradation level of 133. According to the coding for display data determined in the coding table, when a discharge cell displays gradation 133 or higher, subfield SF7 as the first subfield with the smallest luminance weight in the second subfield group has no light emission.

Similarly, the coding table shown in FIG. 9 has the gradation threshold at a gradation level of 87. According to the coding for display data determined in the coding table, when a discharge cell displays gradation 87 or higher, subfield SF7 as the first subfield with the smallest luminance weight in the second subfield group has no light emission.

As described above, the coding for display data determined in the structure of the embodiment, when a discharge cell displays gradation higher than the gradation threshold, the first subfield in the second subfield group has no light emission.

The emission control above is effective in displaying gradation higher than the gradation threshold in a discharge cell. That is, by virtue of the control, when the address operation is performed in the second subfield in the second subfield group, decrease in amplitude Vscn of scan pulses necessary for stable address discharge is expected. As a result, stable address operation is performed in the subfield.

The emission control is also effective in displaying gradation lower than the gradation threshold in a discharge cell. By virtue of the control, a sufficient number of gradation levels are maintained for displaying image on panel 10. The control decreases a noisy feeling on display image, allowing panel 10 to have good image display.

The structure of the embodiment, as described above, has advantage effect both on high gradation display and low gradation display; a stable address discharge is generated even when a discharge cell displays a gradation having the gradation threshold or higher, and a sufficient number of gradation levels are maintained even when a discharge cell displays gradation lower than the gradation threshold. Further, the aforementioned both effects are achieved by properly determining the gradation threshold so as to be suitable for the characteristics of panel 10 and specifications of the plasma display apparatus.

In the example described in the exemplary embodiments, one field is divided into two, the first subfield group and the second subfield group, but it is not limited to. The structure of the embodiment is also applicable to subfield structures where one field is divided into three or more subfield groups.

Each circuit block shown in the exemplary embodiments of the present invention may be formed as an electric circuit that performs each operation shown in the exemplary embodiment, or formed of a microcomputer programmed so as to perform the similar operation, for example.

In the example described in the exemplary embodiments, one pixel is formed of discharge cells of three colors of R, G, and B. Also a panel that includes discharge cells that form a pixel of four or more colors can use the configuration shown in this exemplary embodiment and provide the same advantage.

The aforementioned driver circuit is only shown as an example in the exemplary embodiments of the present invention. The present invention is not limited to the structure of the driver circuit.

The specific numerical values shown in the exemplary embodiments of the present invention are set based on the characteristics of panel 10 that has a 50-inch screen and 1024 display electrode pairs 24, and simply show examples in the exemplary embodiment. The present invention is not limited to these numerical values. Preferably, each numerical value is set optimally for the characteristics of the panel, the specifications of the plasma display apparatus, or the like. Variations are allowed for each numerical value within the range in which the above advantages can be obtained. Further, the number of subfields, the luminance weights of the respective subfields, or the like is not limited to the values shown in the exemplary embodiments of the present invention. The subfield structure may be switched based on image signals, for example.

### INDUSTRIAL APPLICABILITY

The present invention allows panel 10, even having a high-definition large-sized screen, to achieve a sufficient number of gradations to be displayed and stable address discharge. Thus, the present invention is useful in providing a method for driving a panel and a plasma display apparatus.

### Reference Marks in the Drawings

10 panel
22 scan electrode
23 sustain electrode
24 display electrode pair
32 data electrode
51 image data processing circuit
52 data electrode driver circuit
53 scan electrode driver circuit
54 sustain electrode driver circuit
55 timing generation circuit
100 plasma display apparatus
L1, L2, L4 ramp voltage
L3 erasing ramp voltage

1. A plasma display apparatus comprising:
a plasma display panel having a plurality of discharge cells, each of the discharge cells including a data electrode and a display electrode pair which is formed of a scan electrode and a sustain electrode; and
a driver circuit for driving the plasma display panel,
wherein one field is formed by a plurality of subfields, each of the subfields having:
an address period for applying address pulses to the discharge cell to be lit; and
a sustain period for generating sustain pulses corresponding in number to luminance weight and applying the sustain pulses to the display electrode pair,
wherein the driver circuit forms the one field of a first subfield group and a second subfield group temporally successive to the first subfield group, each of the first subfield group and the second subfield group having a plurality of temporally successive subfields, the driver circuit determines luminance weight to each subfield such that the luminance weight increases in an order of occurrence of the subfields and a first subfield in the second subfield group has luminance weight smaller than luminance weight of a last subfield in the first subfield group, and when a gradation having a level greater than a gradation threshold is to be displayed on the panel, the driver circuit determines that the first subfield in the second group has no light emission.

2. A method for driving a plasma display panel having a plurality of discharge cells, each of the discharge cells including a data electrode and a display electrode pair which is formed of a scan electrode and a sustain electrode; and
a driver circuit for driving the plasma display panel,
wherein one field is formed by a plurality of subfields, each of the subfields having:
an address period for applying address pulses to the discharge cell to be lit; and
a sustain period for generating sustain pulses corresponding in number to luminance weight and applying the sustain pulses to the display electrode pair,
the method comprising:
forming the one field of a first subfield group and a second subfield group temporally successive to the first subfield group, each of the first subfield group and the second subfield group having a plurality of temporally successive subfields;
determining luminance weight to each subfield such that the luminance weight increases in an order of occurrence of the subfields and a first subfield in the second subfield group has luminance weight smaller than luminance weight of a last subfield in the first subfield group; and
determining the first subfield in the second group to have no light emission when a gradation having a level greater than a gradation threshold is to be displayed on the panel.
